(19) United States
(12) Patent Application Publication
(10) Pub. No.: US 2023/0305223 A1
(43) Pub. Date: Sep. 28, 2023

(54) OPTICAL CONNECTOR

(71) Applicant: NIPPON TELEGRAPH AND TELEPHONE CORPORATION, Tokyo (JP)

(72) Inventors: Yoko YAMASHITA, Musashino-shi, Tokyo (JP); Kazuhide NAKAJIMA, Musashino-shi, Tokyo (JP); Takashi MATSUI, Musashino-shi, Tokyo (JP)

(73) Assignee: NIPPON TELEGRAPH AND TELEPHONE CORPORATION, Tokyo (JP)

(21) Appl. No.: 18/019,193

(22) PCT Filed: Aug. 5, 2020
(86) PCT No.: PCT/JP2020/029925

§ 371 Date: Feb. 1, 2023

(51) Int. Cl. G02B 6/028; G02B 6/38

(52) U.S. Cl. CPC G02B 6/0288; G02B 6/3825

(57) ABSTRACT

An object of the present invention is to provide a simple method capable of reducing MDL after construction of a transmission path.

An optical connector 301 is an optical connector including a multimode optical fiber 11, in which a core 20 of the multimode optical fiber 11 includes a plurality of cavities 25 along a central axis. The optical connector 301 further includes a ferrule 12 surrounding the multimode optical fiber 11 and a connector plug 13 serving as a connection with another optical connector. The shape of the optical connector 13 is a shape of a generally used SC connector, FC connector, MT connector, or the like.

### TECHNICAL FIELD

The present disclosure relates to an optical connector that compensates for inter-mode gain difference of signal light propagating through a transmission path.

### BACKGROUND ART

In recent years, Internet traffic continues to increase due to diversification of services, and transmission capacity has been dramatically increased due to increase in a transmission rate and increase in the number of multiplexed wavelengths by wavelength division multiplexing (WDM) technology. Furthermore, in recent years, further expansion of the transmission capacity is expected due to digital coherent technology that has been actively studied. In a digital coherent transmission system, the frequency utilization efficiency has been improved using a multi-level phase modulation signal, but a higher signal-to-noise ratio is required. However, in a transmission system using a conventional single mode fiber (SMF), the transmission capacity is expected to be saturated at 100 Tbit/sec due to input power limitation caused by non-linear effect in addition to a theoretical limit, and further increase in the capacity has been difficult.

In order to further increase the transmission capacity in the future, a medium that implements innovative transmission capacity expansion is required. Therefore, mode-multiplexed transmission using a multimode fiber (MMF) by which improvement in a signal-to-noise ratio and space utilization efficiency can be expected using a plurality of propagation modes in an optical fiber as channels has attracted attention. Hitherto, high-order modes propagating in a fiber have been a factor of signal degradation, but active use thereof has been studied due to development of digital signal processing, multiplexing and demultiplexing technology, and the like (See, for example, Non Patent Literature 1 and 2).

In addition to the expansion of the transmission capacity, studies have also been made on extending the distance of the mode-multiplexed transmission, and a report of 527 km transmission using a non-coupled 12 core fiber capable of three mode propagation has been made (See, for example, Non Patent Literature 3).

### CITATION LIST

### Non Patent Literature

Non Patent Literature 1: N. Hanzawa et al., “Demonstration of Mode-Division multiplexing Transmission Over 10 km Two-mode Fiber with Mode Coupler” OFC2011, paper OWA4
Non Patent Literature 2: T. Sakamoto et al., “Modal Dispersion Technique for Long-haul Transmission over Few-mode Fiber with SIMO Configuration” ECOC2011, We.10.P1.82
Non Patent Literature 3: K. Shibahara et al. “Dense SDM (12-Core×3-Mode) Transmission Over 527 km With 33.2-ns Mode-Dispersion Employing Low-Complexity Parallel MIMO Frequency-Domain Equalization,” J. Lightw. Technol., vol. 34, no. 1 (2016).
Non Patent Literature 4: X. Zhao et al. “Mode converter based on the long-period fiber gratings written in the six-mode fiber,” ICOCN, 2017.
Non Patent Literature 5: T. Fujisawa et al., “One chip, PLC three-mode exchanger based on symmetric and asymmetric directional couplers with integrated mode rotator,” OFC 2017, Paper. W1b.2.
Non Patent Literature 6: M. Salsi et al.,“A Six-mode erbium-doped fiber amplifier,” ECOC 2012, Paper. Th.3.A.6.
Non Patent Literature 7: Y. Jung et al.,“Reconfigurable modal gain control of a few-mode EDFA supporting six spatial modes,” IEEE Photonics Technology Letters, vol. 26, No. 11, June (2014)

### SUMMARY OF INVENTION

### Technical Problem

In extending the distance of the mode-multiplexed transmission, inter-mode loss difference (differential modal attenuation: DMA) generated in a transmission path and inter-mode gain difference (differential modal gain: DMG) generated in an optical amplifier are important in order to perform long-distance transmission. In Non Patent Literature 3, in order to implement the long-distance transmission, adjustment is performed such that inter-mode loss difference (mode dependent loss: MDL) including DMA and DMG is 0.2 dB or less in one span. In Non Patent Literature 3, a spatial filter type inter-mode loss difference compensator is used to give loss of approximately 3 dB larger than that of a linearly polarized (LP)11 mode to an LP01 mode, thereby contributing to reduction of the MDL.

However, the spatial gain equalizer as in Non Patent Literature 3 uses a lens, a filter for giving loss to a specific mode, or the like in addition to a fiber, and thus has issues that the structure is complicated and precise alignment work is required to suppress crosstalk between propagation modes.

Furthermore, in a method of reducing MDL using an optical fiber including cavities in a core, the optical fiber is fused and connected to an optical fiber of a transmission path in advance to construct the transmission path, and thus the transmission path is difficult to be inserted after the construction. Therefore, in this method, the MDL of the transmission path is predicted in advance, and an optical fiber capable of reducing the MDL is prepared to construct the transmission path. That is, the method has an issue that the effect of reducing MDL of a transmission path is difficult to be sufficiently obtained in a case where the predicted MDL is not accurate.

Therefore, in order to solve the above issues, an object of the present invention is to provide a simple method capable of reducing MDL after construction of a transmission path.

### Solution to Problem

In order to achieve the above object, the present description discloses an optical connector capable of reducing MDL by being connected to a transmission path.

Specifically, an optical connector according to the present invention is an optical connector including a multimode optical fiber, in which a core of the multimode optical fiber includes a plurality of cavities along a central axis. A plurality of optical connectors having different loss ratios between a fundamental mode and high-order modes are prepared in advance, MDL of a constructed transmission path is measured, and an optical connector capable of improving the MDL is selected and connected to the transmission path. Therefore, the present invention can provide a simple method (optical connector) capable of reducing MDL after construction of a transmission path.

Furthermore, the cavities of the optical connector according to the present invention are ellipsoids, and a major axis direction of one of the cavities is different from a major axis direction of another one of cavities. In a case where the cavity portions are ellipsoids, inter-degeneration-mode loss difference of the high-order modes may occur. In such a case, by the major axis direction of an ellipsoid for each of the cavity portions being changed, the inter-degeneration-mode loss difference of the high-order modes can be averaged and the loss difference can be reduced.

### Advantageous Effects of Invention

The present invention can provide a simple method (optical connector) capable of reducing MDL after construction of a transmission path.

### BRIEF DESCRIPTION OF DRAWINGS

FIG. 1 is a diagram illustrating an optical connector according to the present invention.

FIG. 2 is a cross-sectional view of a multimode optical fiber included in the optical connector according to the present invention and a diagram illustrating its refractive index profile.

FIG. 3 is a diagram illustrating inter-mode loss difference of the optical connector according to the present invention.

FIG. 4 is a diagram illustrating inter-mode loss difference of the optical connector according to the present invention.

FIG. 5 is a diagram illustrating a cross-sectional view of the multimode optical fiber included in the optical connector according to the present invention.

FIG. 6 is a diagram illustrating a cross-sectional view of a multimode optical fiber included in an optical connector according to the present invention.

FIG. 7 is diagrams illustrating inter-mode loss difference of the optical connector according to the present invention. (a) is a reference example, and (b) is a practical example.

FIG. 8 is a diagram illustrating a connection example of the optical connector according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference signs in the present description and the drawings indicate the same components.

### First Embodiment

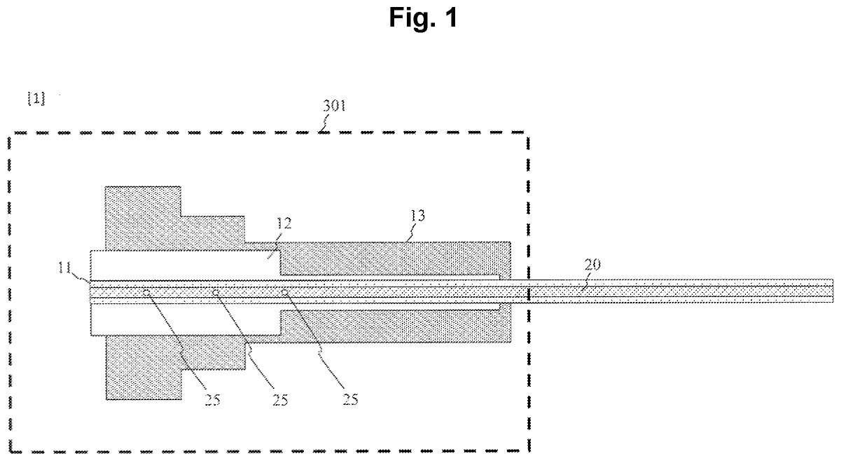

FIG. 1 is a cross-sectional view illustrating structure of an optical connector 301 of the present embodiment. The optical connector 301 is an optical connector including a multimode optical fiber 11, in which a core 20 of the multimode optical fiber 11 includes a plurality of cavities 25 along a central axis. The optical connector 301 further includes a ferrule 12 surrounding the multimode optical fiber 11 and a connector plug 13 serving as a connection with another optical connector. The shape of the optical connector 13 is a shape of a generally used subscriber connector (SC connector), ferrule connector (FC connector), mechanical transfer connector (MT connector), or the like.

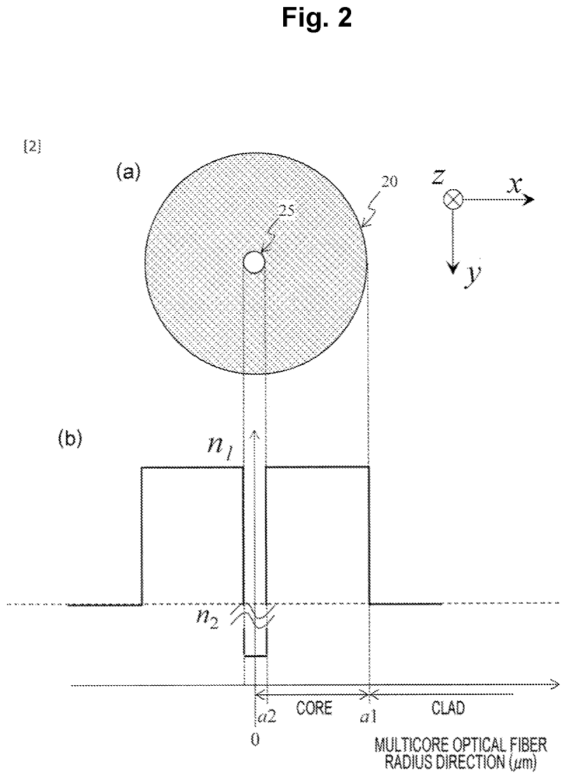

FIG. 2 is diagrams illustrating a core cross section (a) of the multimode optical fiber 11 capable of performing loss difference compensation and its refractive index distribution (b). Here, the z direction is an optical axis direction (central axis direction of the multimode optical fiber 301). Note that FIG. 2 is a cross-sectional view of a portion where a cavity 25 exists. A cross section of a portion where a cavity does not exist is a uniform core region. Here, the core radius, the cavity radius, the refractive index of the core, and the refractive index of a clad are a1, a2, n1, and n2, respectively. Furthermore, the relative refractive index difference Δ of the core with respect to the clad is as follows.

Δ=(n1²−n2²)/2n1²

In general, in a multimode optical fiber, confinement in a fundamental mode tends to be stronger than that in high-order modes, and propagation loss including bending loss tends to be small. Therefore, in order to reduce MDL in a mode multiplexed transmission system, structure in which excessive loss larger than that in the high-order modes can be given to the fundamental mode will be described. Furthermore, in the present embodiment, an example in which the number of LP modes of the multimode optical fiber is two will be described, but a case where the number of modes is increased can also be considered in a similar manner.

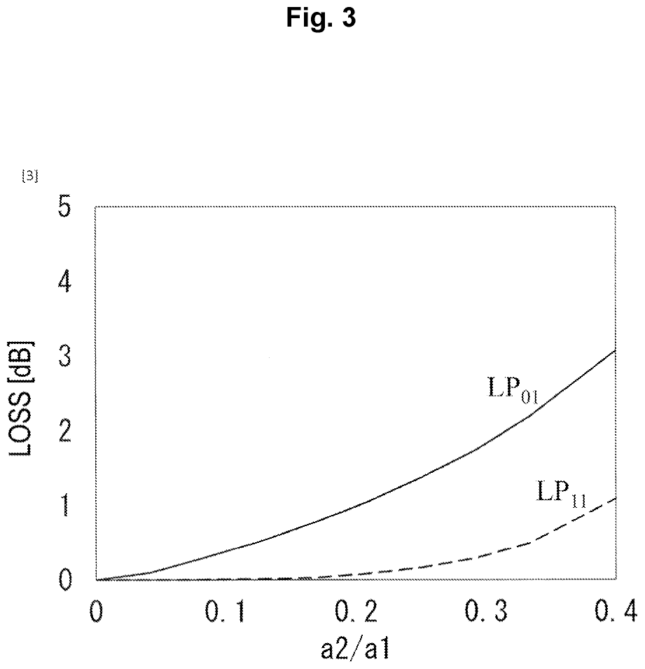

FIG. 3 is a diagram illustrating relation between loss in an LP01 mode and loss in an LP11 mode with respect to the ratio between the cavity radius a2 and the core radius a1. As the ratio a2/a1 increases (the cavity radius increases with respect to the core radius), the loss also increases in both modes, but the loss is larger in the LP01 mode. Therefore, by the ratio a2/a1 being controlled, the range of MDL that can be compensated by the optical connector 301 can be set.

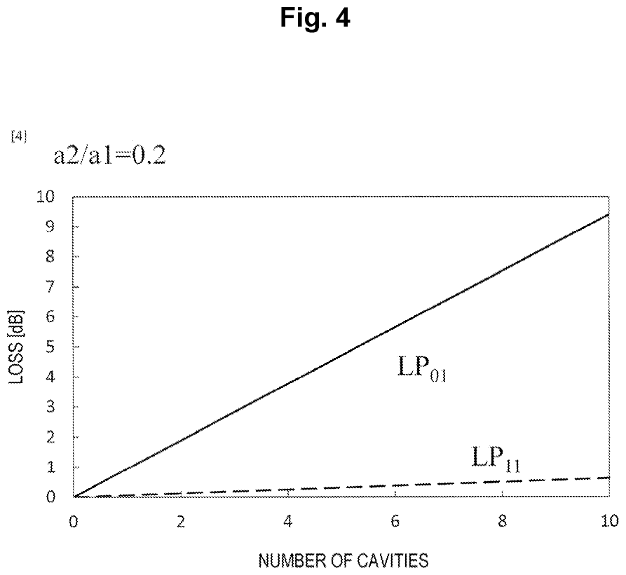

FIG. 4 is a diagram illustrating relation between the number of the cavities and the loss in each of the modes in a case where the ratio a2/a1=0.2. The loss in any modes is proportional to the number of the cavities. Therefore, the loss amount can be set by the number of the cavities being controlled. Note that, although FIG. 4 illustrates data in a case where the radius of each of the cavities 25 is equal to each other, the cavities 25 having different radii may be arranged.

In consideration of FIGS. 3 and 4, the optical connector 301 having various types of inter-mode loss difference can be manufactured by the ratio a2/a1 and the number of the cavities to be formed being adjusted.

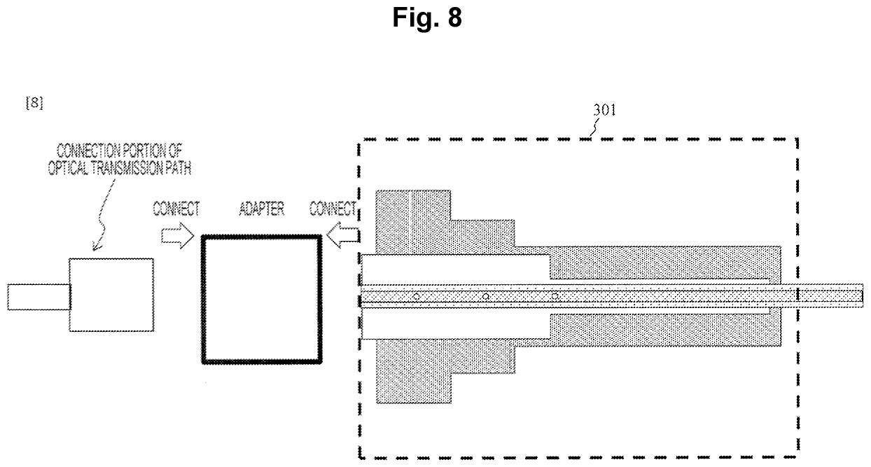

As described above, the optical connector 301 is a cavity provided type connector for compensating inter-mode loss difference. The optical connector 301 is inserted to one or more connection portions in a constructed transmission path to compensate MDL of the transmission path. As an operation procedure, for example, MDL of a transmission path is measured after the transmission path is constructed, and the optical connector 301 having a characteristic of eliminating the MDL is connected to a connection portion of the transmission path (See FIG. 8.). Furthermore, by a plurality of optical connectors 301 being combined and connected in multiple stages, any inter-mode loss difference suitable for the transmission path can be imparted.

As described above, using the optical connector 301, MDL can be reduced without an optical fiber capable of estimating the MDL before construction of a transmission path and reducing the MDL being fused as in the prior art.

### Second Embodiment

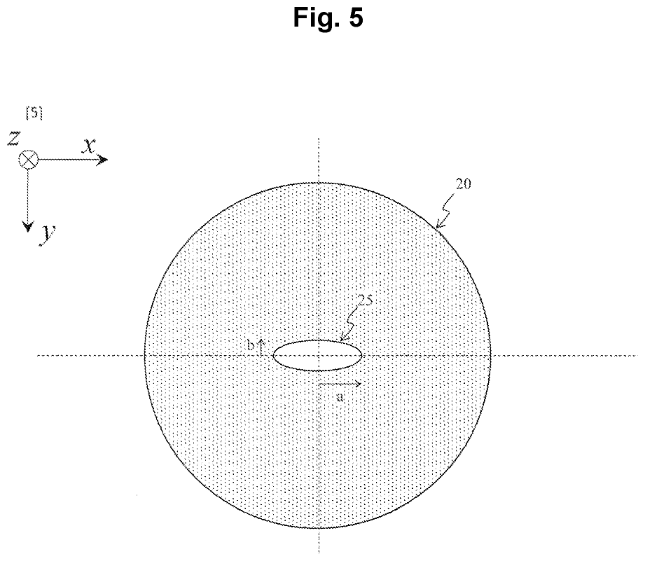

In a case where the cavities 25 of the multimode optical fiber 11 described in the first embodiment are attempted to be formed by femtosecond laser processing from the side surface of the optical fiber, the cavities may be distorted into elliptical shapes due to focal aberration. FIG. 5 is a diagram illustrating a core cross section of the multimode optical fiber 11 in a case where the cavities 25 are ellipsoids. Here, the z direction is an optical axis direction (central axis direction of the multimode optical fiber 301). In this drawing, the cavities 25 are ellipsoids having a major axis (radius a) in the x direction and a minor axis (radius b) in the y direction.

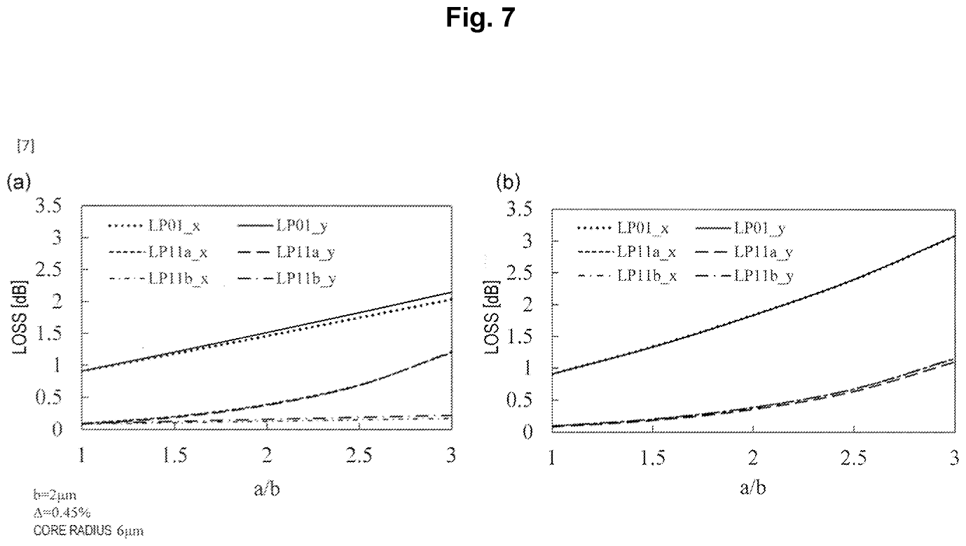

The presence of such ellipsoidal cavities may increase degenerate mode dependency of the LP11 mode. FIG. 7(a) is a diagram illustrating polarization degeneration mode dependency of the LP01 mode and the LP11 mode due to the ellipsoidal cavities. For the LP01 mode, there is no large difference in loss in both the x direction and the y direction. However, in the LP11 mode, loss in an LP11a mode is larger than that in an LP11b in both the x direction and the y direction. That is, the loss applied to modes varies depending on the shape of the cavities 25.

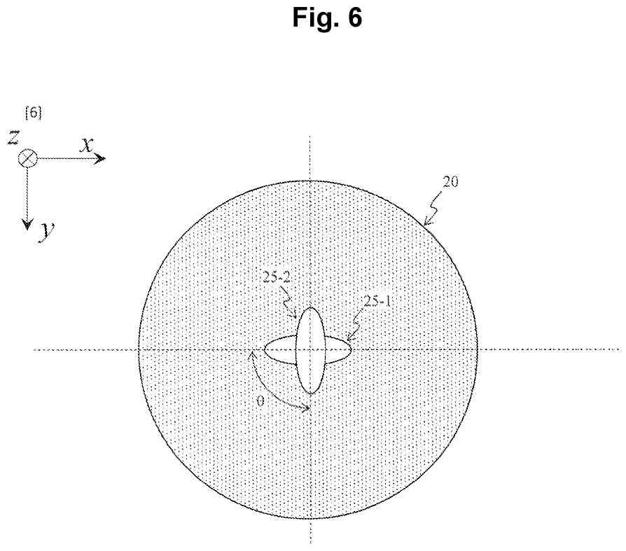

Therefore, in the present embodiment, in order to eliminate the degeneration mode dependency of the LP11 mode as illustrated in FIG. 7(a), the major axis direction of one of the cavities is different from the major axis direction of another one of the cavities. FIG. 6 is a diagram in which two core cross sections of a multimode optical fiber 11 of the present embodiment are overlapped. The present embodiment is an example in which the major axis direction of a cavity 25-1 and the major axis direction of a cavity 25-2 are shifted by 90° (θ=90°).

Two cavities 25 are formed by the irradiation direction of femtosecond laser being changed and the major axes being shifted by 90°, whereby the asymmetry due to the ellipsoids as described in FIG. 7(a) can be improved. FIG. 7(b) is a diagram illustrating inter-degeneration-mode loss difference in a case where the two cavities 25 are formed with the major axes shifted by 90° as in FIG. 6. In FIG. 7(a), there is loss difference between the LP11a and the LP11b, but in FIG. 7(b), the loss difference between the LP11a and the LP11b is eliminated. That is, the degeneration mode dependency of the LP11 mode can be greatly improved by the cavities that are ellipsoids in different major axis directions being arranged.

In the present embodiment, a case where there are two cavities 25 has been described, but the number of the cavities 25 is not limited to two and may be three or more. In this case, the shift amount of the major axis of each of the cavities is not limited to 90°. For example, in a case where the number of the cavities is N, the shift amount of the major axes of the cavities can be set to 180°/N. Furthermore, the cavities 25 may be different from each other in the major axis direction, or may be different in the major axis direction for each of a plurality of cavities.

### [Point of Invention]

Using a connector including an optical fiber including cavities, any loss difference can be imparted according to a transmission path, and loss difference of the transmission path can be controlled.

### [Advantageous Effects of Invention]

By cavity portions being formed inside an optical connector, loss difference can be easily imparted even after construction of a transmission path at a connection point.

### REFERENCE SIGNS LIST

11 Multimode optical fiber

### 12 Ferrule

13 Connector plug

### 20 Core

### 25, 25-1, 25-2 Cavity

301 Optical connector

1. An optical connector comprising a multimode optical fiber,
wherein a core of the multimode optical fiber comprises a plurality of cavities along a central axis.

2. The optical connector according to claim 1, wherein the cavities are ellipsoids, and a major axis direction of one of the cavities is different from a major axis direction of another one of cavities.
